(19) United States
(12) Patent Application Publication
(10) Pub. No.: US 2008/0262872 A1
(43) Pub. Date: Oct. 23, 2008

(54) Method For Delivering Subjective Surveys Linked to Subjective and Objective Data

(75) Inventors: Jeffrey S. Perry, Sunnyvale, CA (US); Brian Zhou, San Jose, CA (US); James McHenry Rueter, Naples, FL (US); Yue-Roe Wu, Los Altos, CA (US); Tho Van Le, Cupertino, CA (US); Dan Barton, Boxford, MA (US); Debra Kay Frantz, Foster City, CA (US)

Correspondence Address: PHILIPS INTELLECTUAL PROPERTY & STANDARDS, 595 MINER ROAD, CLEVELAND, OH, 44143, US

(73) Assignee: KONINKLIJKE PHILIPS ELECTRONICS N.V., Eindhoven (NL)

(21) Appl. No.: 11/568,349

(22) PCT Filed: Mar. 30, 2005
(86) PCT No.: PCT/IB2005/051072

§ 371 Date: Oct. 26, 2006

Related U.S. Application Data
(60) Provisional application No. 60/567,065, filed on Apr. 30, 2004.

(51) Int. Cl. G06Q 50/00

(52) U.S. Cl. 705/3

(57) ABSTRACT

A patient interaction apparatus 10 includes a medical server 13 that generates a reflexive survey as a result of items of interest (such as abnormal or unexpected vital signs) in objective or subjective data reported from a patient interface device 11. The survey of the present invention reacts to objective results with the intent of probing into the patient's current condition. The patient survey of the present invention specifically probes why a patient's weight, blood pressure, or pulse rate, to name only a few examples, may be higher than expected. Various methods for determining the trigger conditions and the elimination of erroneously reported vital signs are set forth. The patient's objective or subjective data includes one or more of the following: blood pressure, pulse rate, temperature, weight, electrocardiogram, electroencephalogram, brain wave, breathing pattern, biochemical measurements, serum glucose, blood gasses, physiologic data, non-physiologic data, exercise or activity measures, presence or absence measures, or any function of objective or subjective data measurable or deducible regarding the patient.

The present invention relates generally to methods and apparatuses for interviewing patients, and more particularly to a method and apparatus for interviewing a patient using a survey.

Patients often complete generic surveys regarding their health. For example, U.S. Pat. No. 6,168,563 discloses a system and method that enables a health care provider to monitor and manage a health condition of a patient. The system includes a health care provider apparatus operated by a health care provider and a remotely programmable patient apparatus that is operated by a patient. The health care provider develops a script program using the health care provider apparatus and then sends the script program to a remotely programmable patient apparatus through a communications network, such as the World Wide Web. The script program is a computer-executable patient protocol that provides information to the patient about the patient's health condition and that interactively monitors the patient health condition by asking the patient questions and by receiving answers to those questions. The answers to these health related questions are then forwarded as patient data from the remotely programmable patient apparatus to the health care provider apparatus through the communications network. The patient data may also include information supplied by a physiological monitoring device, such as a blood glucose monitor that is connected to the remotely programmable patient apparatus. When the patient data arrives at the health care provider apparatus, the patient data is processed for further management of the patient's health condition by the health care provider, such as forwarding another script program to the remotely programmable patient apparatus.

In addition, U.S. Pat. No. 4,803,625 discloses a personal health monitor that includes sensors for measuring patient weight, temperature, blood pressure, and ECG waveform. The monitor is coupled to a central unit via modems and includes a computer which is programmed to prompt a patient to take prescribed medication at prescribed times, to use the sensors to measure prescribed health parameters, and to supply answers to selected questions. Medication compliance information, test results, and patient answers are compiled in a composite log, which is automatically transmitted to the central unit. The computer is also programmed automatically to disconnect the monitor from an alternating current power source and to rely on internal battery power during certain periods of patient-monitor interaction, such as during use of the ECG module. In this way, danger to the patient and complexity of the ECG module are minimized. The computer is also programmed to compare measured test information with predetermined expected values, and in the event of a discrepancy, to collect additional information from the patient to assist trained personnel at the central unit in interpreting the composite log. The computer is also programmed to alert the central unit promptly in the event one or more measured parameters falls outside of a prescribed normal range. The normal range for a given parameter is made to vary in accordance with the measured value of one or more other parameters in order to reduce the incidence of false alarms.

The surveys employed in the above systems are selected for the patient in advance, without knowledge regarding the patient's daily or current vital signs. Often; patients would receive whatever survey was scheduled, sometimes weeks in advance without any knowledge of a patient's medical signs.

The present invention is therefore directed to the problem of developing a method for obtaining information that is specifically tailored to a patient's current medical condition.

The present invention solves these and other problems by providing a survey that is generated as a result of a variety of data obtainable from the patient, such as abnormal or unexpected vital signs, which could constitute objective data or subjective data. Examples could include objective data, such as a vital sign that lies outside a normal range, or subjective data, such as a response to “how are you feeling” or even results from a prior survey. For example, a basic survey ‘A’ could be sent to the patient to broadly assess their condition. Once returned to the ‘back end’, this survey could be ‘scored’ using some algorithm, and some logic run against that score might trigger another survey. Concretely, a daily survey might ask high-level questions about how the patient is doing. Some algorithm run on the responses to this survey could generate a score that indicated that the patient might be at risk for depression. In response, the back-end could automatically send a survey focused on determining depression status, to confirm and provide additional detail on the original indication. Thus, the survey of the present invention reacts to subjective results with the intent of probing into the patient's current condition. As opposed to the prior art, in which patients might receive a preset survey despite the fact that the patient's vital signs were markedly abnormal at the time the patient survey was being completed, the patient survey of the present invention specifically probes why a patient's weight, blood pressure, or pulse rate, to name only a few examples, may be higher than expected.

According to other aspects of the present invention, various methods for determining the trigger conditions and the elimination of erroneously reported vital signs are set forth.

According to one exemplary embodiment of a method for triggering a survey a patient's abnormal condition is determined by comparing the latest reported measurement against a preset threshold, a previously recorded value or both. The comparison criteria can be an absolute value (high or low threshold), or relative variances (e.g., five percent in the last seven days, three pounds within twenty-four hours, etc.).

According to another aspect of the present invention, a filter is employed to eliminate the use of erroneous measurements that fall outside of the reasonable range (e.g., a doubling of weight in one day).

In addition, the present invention gives the reflexive survey a higher priority in delivering and presentation than that of a scheduled survey. A generated reflexive survey would reach the patient before a regularly scheduled survey. A generated reflexive survey would also expire after a specific period, as the condition of the patient may change and new measurements are presumably taken over time.

These and other advantages will be apparent upon review of the detailed description in light of the following drawings.

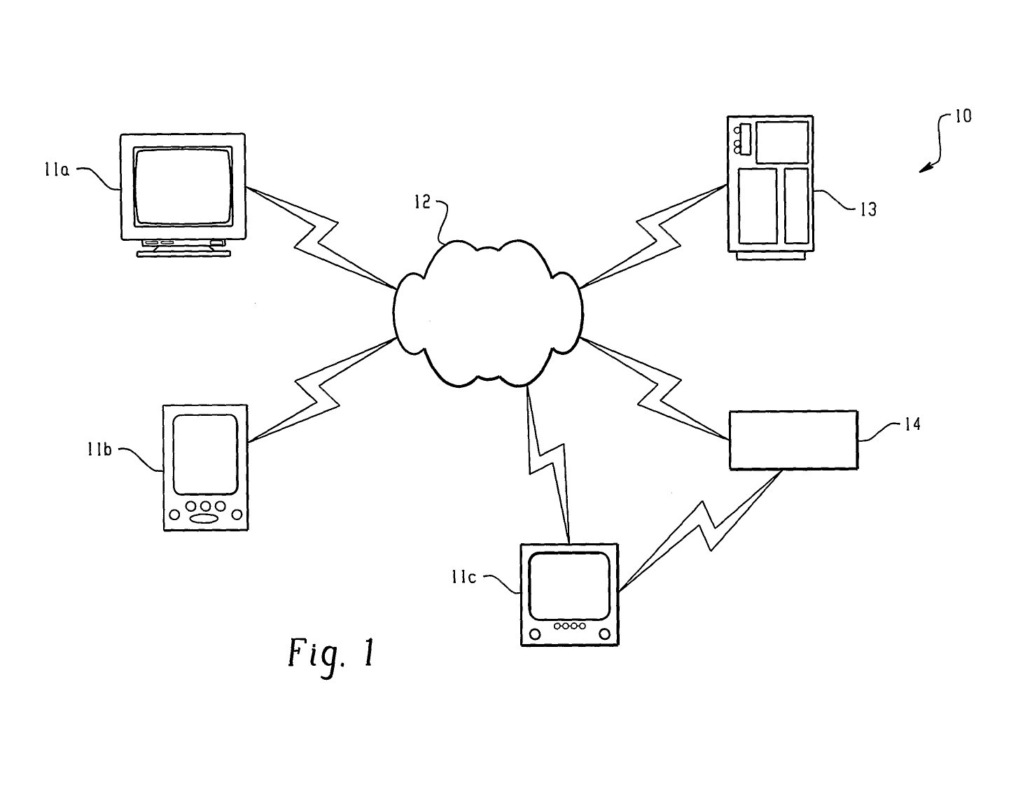

FIG. 1 illustrates an exemplary embodiment of an apparatus for obtaining medical information from a patient according to one aspect of the present invention.

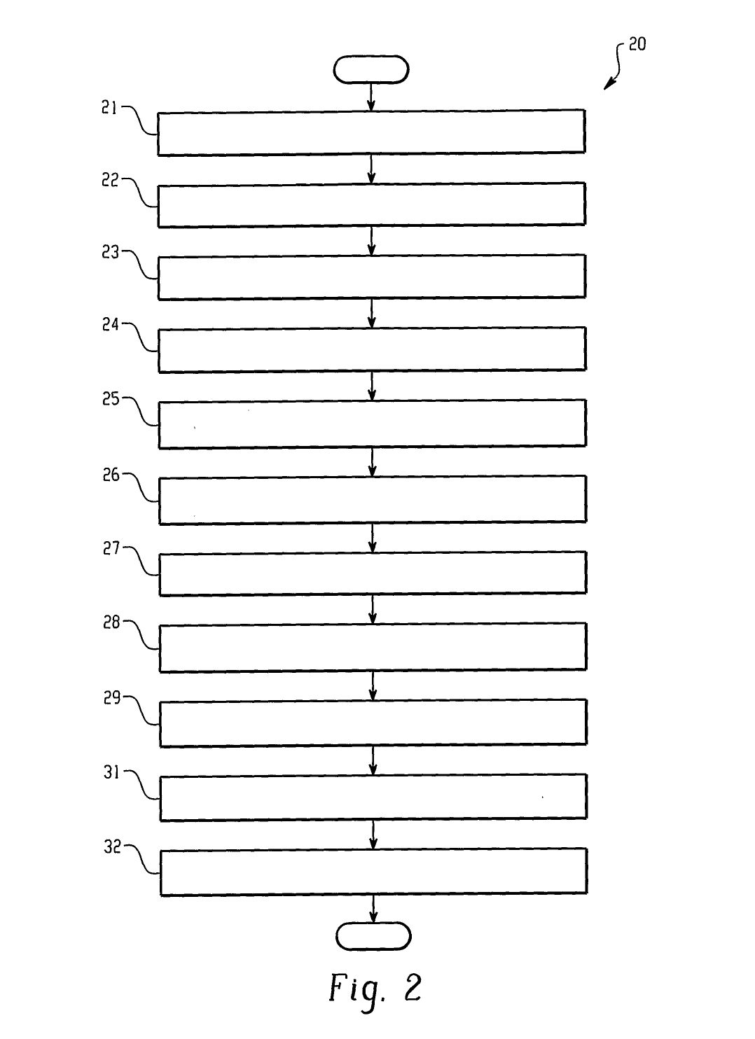

FIG. 2 depicts an exemplary embodiment of a method for obtaining medical information from a patient according to another aspect of the present invention.

It is worthy to note that any reference herein to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Turning to FIG. 1, in an exemplary embodiment 10 of a system of telemedicine vital signs are reported from a patient's home using a Patient Interactive Survey Device 11a-c to a monitoring server 13. The server 13 generates unique surveys for the patient based on reported vital sign values from the patient and pre-configured thresholds. The server may also generate surveys based on objective or subjective data, such as how one feels, abnormal vital signs, clinically significant data, or even a prior completed (or not completed in time) survey.

The Patient Interactive Survey Device 11 can be a personal computer, laptop, handheld computer, Palm Pad, automated voice response system or other device configured to receive data, display the data and to accept input from a patient.

Another possible embodiment of the Patient Interactive Survey Device 11 might involve several devices to accomplish the input/output tasks herein. For example, instead of an integrated device, such as a laptop or a computer, the Patient Interactive Survey Device might comprise a combination of: (1) code executing in a processor in a set-top box, (2) a TV, and (3) a remote control. Other possibilities are also possible—perhaps using the combination of a cell phone and a TV. The Patient Interactive Survey Device 11 receives reflexive surveys. As used herein, the term “reflexive” survey means any survey that is generated in response (e.g., reflexively) to some subjective or objective trigger. For reference, the other survey types we define are (a) “scheduled”, for those that are calendar-driven, and (b) “one-time”, for a survey that is specified explicitly by a physician or care provider. The Patient Interactive Survey Device 11 also enables the patient to input answers to the survey and store them for later forwarding to the medical server 13.

Alternatively, the Patient Interactive Survey Device 11 can be that as disclosed in U.S. Pat. No. 6,168,563, which is hereby incorporated by reference as if repeated herein in its entirety, including the drawings.

Moreover the Patient Interactive Survey Device 11 can include parts of the system disclosed in U.S. Pat. No. 4,803,625, which is hereby incorporated by reference as if repeated herein in its entirety, including the drawings.

The preconfigured thresholds used by the server 13 can be of absolute value or a percentage of change from a previous value. In general, these thresholds could pertain to any arbitrary algorithm. Also, the threshold could apply to a ‘score’ of some other subjective data (such as answers to a previous survey). The server 13 then delivers the reflexive survey to the patient's home device 11a-c to probe into the patient's condition. A home device 11a-c (which may be the same as the one that reported the vital sign values) receives the survey and presents the survey to the patient for interaction.

A reflexive survey consists of a list of questions and their possible answers from which the patient can select, and path information to navigate the question list. The questions could be structured into a tree (specifically, a ‘directed acyclic graph’ structure), of which an ordered list is a simple case. The survey can be predefined, or dynamically compiled at the server from available questions. Once the patient has answered the survey, the results are reported to the server 13. The system 10 correlates and makes available both the objective vital signs and the subjective answers for the system user to review. The system may also present a ‘summary’ or ‘score’ view of the subjective answers, to aid quick review of the survey results.

FIG. 1 also shows a measurement device 14, which could be a scale to measure weight, a blood-pressure cuff. This device 14 could be a standalone device, as in the case of a scale or an implanted device, e.g., pacemaker, implantable cardiac defibrillator, and implanted infusion pump. The data from measurement device 14 could be coupled to the Patient Interactive Survey Device 11 (hence the link from the measurement device to the PISD 14) or the data could be coupled directly to the server 13 (hence the other link from the measurement device to the server). Of course, the patient could obtain this data and enter it into the PISD 14 himself.

Turning to FIG. 2, shown therein is an exemplary embodiment of a method for obtaining patient information according to another aspect of the present invention. This method generates a survey in response to received data from the patient, either objective or subjective data (or even a prior survey), which data includes an “item of interest.” This item of interest varies from application or patient, however, it covers any aspect of the patient that one might deem interesting, including any abnormal or medically significant data, patient diagnosis information, patient mental or physical state, or even data that might indicate some improvement in one's personal health or well-being.

In element 21, objective and/or subjective data from a patient is monitored, such as a patient's vital measurements. The system may allow for ‘a-periodic’ monitoring in which samples are not obtained on any fixed or defined time base, but rather, the measurements are obtained whenever they're available. These measurements can include one or more of the following: blood pressure, pulse rate, temperature, weight, electrocardiogram, electroencephalogram, brain wave, breathing pattern, biochemical measurement, etc. The patient can either report these to a patient interface device or the device itself can be recording them. The device may be a free-standing unit, such as a scale or a glucose meter, which the subject places where convenient. Alternatively, this device could be a monitoring unit that is implanted in the patient, such as a sensor on a pacemaker, and implantable cardioverter defibrillator, or an implanted infusion pump. The ‘data’ may also be of the ‘subjective’ variety, such as how does one feel, or other data that can be used to probe a patient's mental or physical health.

In element 22, the patient's data is forwarded or transmitted to a central server from the patient interface device. This can be accomplished via the Internet or any other communications link capable of sending data or files. This element can be a store and forward transfer type communication or simply a real-time communication.

In element 23, the patient's data is received at a central server, along with other patients' data from other patient interface devices. Multiple patients can be monitored in this manner.

In element 24, the received vital measurements are filtered to remove potentially erroneous measurements. This filtering is conducted on all received data.

In element 25, if existing, an item of interest (such as an abnormal measurement or vital sip) is identified. The item of interest need not be ‘abnormal’ or even clinically significant—just “of interest.” For example, the system could send a congratulatory message to someone who had kept his weight under control for the past few weeks.

In element 26, a reflexive survey is generated based on one or more triggering events, such as an identified item of interest, for each patient that has one or more triggering events, by matching a previously created reflexive survey to a received triggering event, such as an identified item of interest. This is accomplished by, for example, matching a received abnormal response to a predetermined reflexive survey. For example, a patient having an abnormal heart rate would be sent a survey designed to query the patient about his heart or other conditions that might affect the heart. Thus, the exemplary embodiment initiates a reflexive survey as a result of abnormal results of some vital measurements received. Thus, the exemplary embodiment customizes on a dynamic basis (or using previously developed questions) questions and answers according to the trigger measurement. The exemplary embodiment determines the trigger conditions of the patient's vital signs. The exemplary embodiment filters the vital signs to eliminate erroneous measurements.

In element 27, the reflexive survey is forwarded to each patient having an identified item of interest. This is accomplished using the Internet or any communications link capable of transmitting data or files. For example, the generated survey could remain on the server to be retrieved/presented to the patient whenever “appropriate”. For example, in the TV/set-top box scenario, the survey could remain at the ‘back end’ until the patient started using the interactive TV application to review his/her surveys.

In element 28, the reflexive survey is presented to the patient via by the patient's interface device.

In element 29, the patient interacts with the reflexive survey via the patient's interface device. This includes displaying the reflexive survey to the patient and obtaining answers to the questions included in the reflexive survey.

In element 31, the completed reflexive survey is forwarded to the central server via the patient's interface device.

In element 32, the central server receives the completed reflexive survey. The results of the survey or just a score or alert summarizing these results may be presented to the clinical user. In addition, one or more surveys may then be generated based on the received completed reflexive survey. In fact, a patient may then interact with the central server via one or more additional surveys depending upon the responses in each completed survey. Note that a scored subjective survey could trigger another subjective survey.

Although various embodiments are specifically illustrated and described herein, it will be appreciated that modifications and variations of the invention are covered by the above teachings and are within the purview of the appended claims without departing from the spirit and intended scope of the invention. For example, certain vital measurements are discussed, however, any physical measurement can be employed without departing from the scope of the present invention. Furthermore, this example should not be interpreted to limit the modifications and variations of the invention covered by the claims, but is merely illustrative of one possible variation.

1. A method for obtaining health information from a patient comprising:
generating a survey in response to one or more triggering events; and
presenting the generated survey to the patient.

2. The method according to claim 1, wherein said one or more triggering events comprises receiving one or more abnormal or unexpected vital signs that exceed a threshold.

3. The method according to claim 1, wherein said one or more triggering events comprises receipt of objective data that matches a criterion.

4. The method according to claim 1, wherein said one or more triggering events comprises receipt of subjective data that matches a criterion.

5. The method according to claim 4, wherein said one or more triggering events comprises receipt of a completed survey.

6. The method according to claim 2, wherein said preset threshold is based on one or more prior vital signals received from the patient.

7. The method according to claim 6, wherein said threshold is determined by any arbitrary function of subjective and/or objective data.

8. The method according to claim 6, wherein said threshold is calculated as a function of data from other patients.

9. The method according to claim 1, further comprising:
filtering received vital signs to eliminate erroneous measurements.

10. The method according to claim 1, further comprising:
attaching an expiration date to the survey so that the survey expires after the attached expiration date.

11. A method for obtaining patient information comprising:
monitoring subjective or objective data from a patient; and
generating a reflexive survey based on received data that includes an item of interest.

12. The method according to claim 11, further comprising:
matching each received item of interest to a previously created reflexive survey.

13. The method according to claim 12, further comprising:
presenting at least one of the matched predetermined reflexive surveys to each patient having the item of interest.

14. The method according to claim 12, further comprising:
interacting by each patient with the matched reflexive survey via the patient's interface device.

15. The method according to claim 11, further comprising:
receiving the patient objective or subjective data at a central server, along with one or more other patients' objective or subjective data from one or more other patient interface devices.

16. The method according to claim 8, further comprising:
identifying one or more items of interest, if any, among the received patients' objective or subjective data.

17. The method according to claim 16, wherein an item of interest includes an abnormal measurement.

18. The method according to claim 17, further comprising:
receiving by the central server a completed reflexive survey; and
generating one or more surveys based on the received completed reflexive survey.

19. The method according to claim 8, wherein said patient's objective or subjective data includes one or more of the following: blood pressure, pulse rate, temperature, weight, electrocardiogram, electroencephalogram, brain wave, breathing pattern, biochemical measurements, serum glucose, blood gasses, physiologic data, non-physiologic data, exercise or activity measures, presence or absence measures, or any function of objective or subjective data measurable or deducible regarding the patient.

20. An apparatus for obtaining health information from a patient comprising:
a patient interactive device to receive objective or subjective data from a patient and to couple to a network to transmit the objective or subjective data and to receive a patient survey; and
a medical server to couple to the network for generating a medical survey in response to receipt of one or more items of interest in the objective or subjective data from the patient interactive device and to transmit the medical survey to the patient.
